(19) United States
(12) Patent Application Publication
(10) Pub. No.: US 2024/0165896 A1
(43) Pub. Date: May 23, 2024

(54) FIBER COMPOSITE MATERIAL AND PREPARATION METHOD THEREOF

(71) Applicant: NINGBO INSTITUTE OF MATERIALS TECHNOLOGY AND ENGINEERING, CHINESE ACADEMY OF SCIENCES

(72) Inventors: Yunfu OU, Ningbo (CN); Dongsheng MAO, Ningbo (CN); Longqiang WU, Ningbo (CN); Hongchen ZHAO, Ningbo (CN); Kun LIU, Ningbo (CN); Yiting WENG, Ningbo (CN); Anran FU, Ningbo (CN)

(73) Assignee: NINGBO INSTITUTE OF MATERIALS TECHNOLOGY AND ENGINEERING, CHINESE ACADEMY OF SCIENCES, Ningbo (CN)

(21) Appl. No.: 18/219,157

(22) Filed: Jul. 7, 2023

Related U.S. Application Data
(63) Continuation of application No. PCT/CN2022/135145, filed on Nov. 29, 2022.

(30) Foreign Application Priority Data
Nov. 23, 2022 (CN) 202211472167.9

(51) Int. Cl. B29C 70/68; B29C 70/00; B82Y 30/00

(52) U.S. Cl. CPC B29C 70/683; B29C 70/003; B29C 70/682; B82Y 30/00; B29K 2307/04; B29K 2313/02

(57) ABSTRACT

The present invention relates to the technical field of composite materials, and in particular to a fiber composite material and a preparation method thereof. The preparation method comprises: A) uniformly dispersing nanoparticles in a solvent to obtain a nanoparticle dispersion; B) uniformly spray-coating the nanoparticle dispersion on a chopped fiber nonwoven fabric, and drying the fabric to obtain a nano-modified chopped fiber nonwoven fabric; C) intercalating the nano-modified chopped fiber nonwoven fabric between fiber preforms, and subjecting the obtained material and a resin matrix to composite molding by a molding process to obtain a fiber composite material. In the present invention, firstly nanoparticles are uniformly dispersed in a solvent to obtain a nanoparticle dispersion; secondly, the chopped fiber and the nanoparticles cooperate to construct a multi-scale interlaminar toughening phase, which significantly improves the interlaminar fracture toughness of the fiber composite material.

### CROSS REFERENCE TO RELATED APPLICATIONS

This application is a US continuation application based upon International Application No. PCT/CN2022/135145, titled “FIBER COMPOSITE MATERIAL AND PREPARATION METHOD THEREOF”, filed on Nov. 29, 2022, which claims the priority of Chinese Patent Application No. 202211472167.9, titled “FIBER COMPOSITE MATERIAL AND PREPARATION METHOD THEREOF”, filed on Nov. 23, 2022, with the China National Intellectual Property Administration, the disclosures of each of which are hereby incorporated herein by reference in their entirety.

### FIELD

The present invention relates to the technical field of composite materials, and in particular to a fiber composite material and a preparation method thereof.

### BACKGROUND

Fiber-reinforced composite materials have excellent properties such as light weight and high strength, and are widely used in fields such as aerospace, automobiles, offshore platforms, and building structure reinforcement. However, this material is usually used in the form of laminated plate products. Due to the characteristics of its layered structure, it has low load-bearing capacity along the thickness direction, and is prone to delamination damage under loads such as in-plane compression, bending, fatigue and lateral impact. Once delamination occurs and spreads inside the laminated plate, the stiffness of the entire structure gradually decreases, eventually leading to catastrophic failure. Therefore, how to effectively suppress the delamination damage of composite materials and improve the interlaminar fracture toughness is a key problem to be solved urgently in the research, development, and application of laminated composite materials.

Interlaminar toughening is a relatively effective mean to suppress the delamination of composite materials. The technical idea is to intercalate a toughening material in the interlaminar resin-rich area where the composite material is prone to delamination, thereby improving the delamination resistance of the composite material. This toughening method basically does not change the original molding process of the fiber composite material, greatly improves the interlaminar fracture toughness of the composite material, and has a good application prospect.

Chinese patent (CN104945852A) discloses a method of interlaminar toughening using micro-nano particles. Specifically, the method comprises firstly evenly spray-coating a mixed solution containing micro-nano particles on a fiber fabric, then placing the fiber fabric in an oven for drying, and then compounding it with a thermosetting resin after the solvent is completely evaporated, to obtain a composite material interlaminar-toughened by micro-nano particles. Although this method improves the interlaminar fracture toughness of the composite material, the improvement effect is limited, and it does not solve the problem of difficulty in uniform dispersion of nanoparticles. In addition, this method requires a process on the basis of the original fiber fabric, which limits the scope of application.

### SUMMARY

In view of this, the technical problem to be solved by the present invention is to provide a fiber composite material and a preparation method thereof. The fiber composite material prepared by the present invention has good interlaminar fracture toughness.

The present invention provides a method for preparing a fiber composite material, comprising steps of:
A) uniformly dispersing nanoparticles in a solvent to obtain a nanoparticle dispersion;
B) uniformly spray-coating the nanoparticle dispersion on a chopped fiber nonwoven fabric, and drying the fabric to obtain a nano-modified chopped fiber nonwoven fabric;
C) intercalating the nano-modified chopped fiber nonwoven fabric between fiber preforms, and subjecting the obtained material and a resin matrix to composite molding by a molding process to obtain a fiber composite material.

Preferably, in step A), the nanoparticles are selected from the group consisting of carbon nanotubes, graphene, nano-silicon dioxide, boron nitride nanotubes/sheets, nanoclays, carbon nanofibers, carbon nanotube fibers and a mixture thereof.

Preferably, in step A), the nanoparticles are grafted with a functional group on the surface thereof;
wherein, the functional group is selected from the group consisting of carboxyl, amino and hydroxyl.

Preferably, in step A), the nanoparticles have a size of less than 2.0 μm.

Preferably, in step A), the solvent is selected from the group consisting of water, ethanol, acetone, and a mixture thereof; and
the nanoparticle dispersion has a mass concentration of 0.1%-5%.

Preferably, in step A), the uniformly dispersing is carried out by a method selected from the group consisting of mechanical stirring, ball milling, grinding, ultrasonic treatment, two/three-roll machine treatment, micro-jet treatment and a mixture thereof.

Preferably, in step B), the chopped fiber nonwoven fabric is prepared by a method comprising:
uniformly dispersing a chopped fiber in water under the action of a surfactant, and subjecting the obtained dispersion to suction filtration to obtain a chopped fiber nonwoven fabric.

Preferably, in step B), the chopped fiber is selected from the group consisting of a carbon fiber, a glass fiber, a steel fiber, an aramid fiber, a silicon carbide fiber, a plant fiber and a mixture thereof;
the chopped fiber has a length of 0.5 to 15 mm; and
the surfactant is selected from the group consisting of polyvinyl alcohol, hydroxypropyl methylcellulose, methylcellulose, carboxymethyl cellulose and a mixture thereof.

Preferably, in step C), the fiber preform is prepared with the fiber fabric laid by lamination;
the resin matrix is selected from the group consisting of epoxy resin, unsaturated polyester, phenol formaldehyde resin, vinyl ester, bismaleimide, polyimide, nylon 6, nylon 66, polyether ether ketone, polyether ketone and a mixture thereof; and
the molding process is selected from the group consisting of vacuum assisted resin transfer molding, resin transfer molding, hand lay-up molding, autoclave molding, wet molding, sheet molding and a mixture thereof.

The present invention further provides a fiber composite material prepared by the above method.

The present invention provides a method for preparing a fiber composite material, comprising steps of: A) uniformly dispersing nanoparticles in a solvent to obtain a nanoparticle dispersion; B) uniformly spray-coating the nanoparticle dispersion on a chopped fiber nonwoven fabric, and drying the fabric to obtain a nano-modified chopped fiber nonwoven fabric; C) intercalating the nano-modified chopped fiber nonwoven fabric between fiber preforms, and subjecting the obtained material and a resin matrix to composite molding by a molding process to obtain a fiber composite material. In the present invention, firstly nanoparticles are uniformly dispersed in a solvent to obtain a nanoparticle dispersion; secondly, the chopped fiber and the nanoparticles cooperate to construct a multi-scale (micron-nano) interlaminar toughening phase, which significantly improves the interlaminar fracture toughness of the fiber composite material. The method provided by the present invention is simple in operation and flexible in processing mode, and does not change the original molding process of the fiber composite material. The method exhibits remarkable effect of interlaminar toughening, and has a huge application prospect.

### BRIEF DESCRIPTION OF DRAWINGS

FIG. 1 is a schematic diagram of the laid fiber composite plate used for fracture toughness test in the Example 1 of the present invention;

FIG. 2 is a diagram of the result of the double cantilever beam test on the fiber composite materials of Example 1 and Comparative examples 1-2;

FIG. 3 is a R curve diagram of the fiber composite materials of Example 1 and Comparative examples 1-2;

FIG. 4 shows a result of the end-notched flexure test on the fiber composite materials of Example 1 and Comparative examples 1-2;

FIG. 5 is SEM images of the mode I fracture surface of the fiber composite material in Example 1 of the present invention.

### DETAILED DESCRIPTION

The technical solutions of the present invention will be clearly and completely described below in conjunction with the examples of the present invention. Apparently, the described examples are only a part of the embodiments of the present invention, rather than all of them. Based on the examples of the present invention, all other examples obtained by those of ordinary skill in the art without making creative efforts are within the protection scope of the present invention.

The present invention provides a method for preparing a fiber composite material, comprising steps of:
A) uniformly dispersing nanoparticles in a solvent to obtain a nanoparticle dispersion;
B) uniformly spray-coating the nanoparticle dispersion on a chopped fiber nonwoven fabric, and drying the fabric to obtain a nano-modified chopped fiber nonwoven fabric;
C) intercalating the nano-modified chopped fiber nonwoven fabric between fiber preforms, and subjecting the obtained material and a resin matrix to composite molding by a molding process to obtain a fiber composite material.

In step A):

Nanoparticles are uniformly dispersed in a solvent to obtain a nanoparticle dispersion.

In some embodiments of the present invention, the nanoparticles are selected from the group consisting of carbon nanotubes, graphene, nano-silicon dioxide, boron nitride nanotubes/sheets, nanoclays, carbon nanofibers, carbon nanotube fibers and a mixture thereof.

The carbon nanotubes can be multi-walled carbon nanotubes.

In some embodiments of the present invention, the nanoparticles are grafted with a functional group on the surface thereof; wherein, the functional group is selected from the group consisting of carboxyl, amino and hydroxyl. Specifically, the nanoparticles can be aminated multi-walled carbon nanotubes, more specifically, aminated multi-walled carbon nanotubes TNSMN1 with a length ranging from 0.5 to 2 μm, an average length of 1.0 μm, and a diameter of <8 nm, produced by Chengdu Organic Chemicals Co., Ltd., Chinese Academy of Sciences.

In some embodiments of the present invention, the nanoparticles have a size of less than 2.0 μm; if the size of the nanoparticles beyond the range, it may be ground to a size of less than 2.0 μm.

In some embodiments of the present invention, the solvent has low viscosity and is volatile, and it is selected from the group consisting of water, ethanol, acetone, and a mixture thereof.

In some embodiments of the present invention, the nanoparticle dispersion has a mass concentration of 0.1%-5%; specifically, 0.6%.

In some embodiments of the present invention, the uniformly dispersing is carried out by a method selected from the group consisting of mechanical stirring, ball milling, grinding, ultrasonic treatment, two/three-roll machine treatment, micro jet treatment and a mixture thereof.

In some embodiments of the present invention, uniformly dispersing nanoparticles in a solvent comprises:
a1) mixing nanoparticles with a solvent, then stirring the resulting mixture with a glass rod, sealing the mixture, and then ultrasonicating it at room temperature (25° C.);
a2) dispersing the ultrasonicated solution by a micro-jet to obtain a nanoparticle dispersion.

In step a1):

In some embodiments, the ultrasonication is performed for 30 min. The ultrasonication can make the nanoparticles distribute relatively uniformly in the solvent.

In step a2):

In some embodiments, the micro-jet dispersion is conducted using a micro-jet high-pressure homogenizer. The nanoparticles are broken apart by the interaction of its strong shear force and impact force.

In some embodiments, the micro jet dispersion is conducted 6 times. In each micro-jet dispersion, the nanoparticles remaining on the inner wall of the equipment need to be flushed by the solvent into the micro jet equipment for dispersion, to reduce the loss of nanoparticles, so that the nanoparticles are dispersed completely uniformly.

In step B):

The nanoparticle dispersion is evenly spray-coated on a chopped fiber nonwoven fabric, and the fabric is then dried to obtain a nano-modified chopped fiber nonwoven fabric. Specifically, the nanoparticle dispersion can be evenly spray-coated on both sides of the chopped fiber nonwoven fabric, and the fabric is then dried to obtain a nano-modified chopped fiber nonwoven fabric.

In some embodiments of the present invention, a material of the chopped fiber nonwoven fabric is selected from the group consisting of a carbon fiber, a glass fiber, a steel fiber, an aramid fiber, a silicon carbide fiber, a plant fiber and a mixture thereof. In some embodiments, a material of the chopped fiber nonwoven fabric is a carbon fiber.

In some embodiments of the present invention, the chopped fiber nonwoven fabric is prepared by a method comprising:
uniformly dispersing a chopped fiber in water under the action of a surfactant, and subjecting the obtained dispersion to suction filtration to obtain a chopped fiber nonwoven fabric.

The chopped fiber is selected from the group consisting of a carbon fiber, a glass fiber, a steel fiber, an aramid fiber, a silicon carbide fiber, a plant fiber and a mixture thereof.

The chopped fiber has a length of 0.5 to 15 mm; specifically, 4 mm.

The surfactant is selected from the group consisting of polyvinyl alcohol, hydroxypropyl methylcellulose, methylcellulose, carboxymethyl cellulose and a mixture thereof.

A mass ratio of the chopped fiber, surfactant and water is 10-100:1-10; 100-1000; specifically, 10:1:1000.

The uniformly dispersing is carried out under stirring.

After the suction filtration, the method may comprise: washing the filter residue with deionized water to remove residual surfactant.

After washing with deionized water, the method may comprise: drying the residue to obtain a chopped fiber nonwoven fabric. The drying is carried out in a vacuum oven.

In some embodiments of the present invention, the chopped fiber nonwoven fabric has a thickness of 10-100 μm, specifically 50 μm.

After the chopped fiber nonwoven fabric is obtained, the nanoparticle dispersion is evenly spray-coated on the chopped fiber nonwoven fabric, and the fabric is then dried to obtain a nano-modified chopped fiber nonwoven fabric.

In some embodiments of the present invention, the uniformly spray-coating is carried out using a high-pressure spray gun. Specifically, the spray gun may be a W-71 Siphon spray gun. The spray gun is connected to an air compressor with an air purifier or a nitrogen bottle. The spray-coating is conducted at an air pressure of 0.1-1.0 MPa, specifically, 0.6 MPa and a distance of 20-40 cm, specifically 30 cm. The nanoparticles are spray-coated at an areal density of 0.1-0.6 g/m², specifically, 0.15 g/m², 0.25 g/m², 0.3 g/m² or 0.5 g/m².

In some embodiments of the present invention, the drying is vacuum drying, which can be performed in a vacuum oven.

In step C):

The nano-modified chopped fiber nonwoven fabric is intercalated between fiber preforms, and the obtained material is subjected with a resin matrix to composite molding by a molding process to obtain a fiber composite material.

In some embodiments of the present invention, the fiber preform is prepared with the fiber fabric laid by lamination.

The construction of fibers in the fiber fabric includes but is not limited to unidirectional, bidirectional and three-dimensional construction. In some embodiments, the fiber fabric is a unidirectional carbon fiber fabric, specifically a Toray T300-3000 unidirectional carbon fiber fabric with a density of 1.76 g/cm³. In some embodiments, the fiber fabric is a glass fiber bidirectional fabric, with an area density of 400 g/m².

The fiber fabric usually has a size of 25 cm×25 cm.

In some embodiments, the fiber preform has 16 layers of fiber fabrics. Specifically, the fiber fabrics are stacked and arranged in a sequence of [0°]₁₆. The nano-modified chopped fiber nonwoven fabric is intercalated between the fiber fabrics of the eighth and ninth layers in the fiber preform.

In some embodiments, the fiber preform has 30 layers of fiber fabrics. Specifically, the fiber fabrics are stacked and arranged in a sequence of [0°]₃₀. The nano-modified chopped fiber nonwoven fabric is intercalated between the fiber fabrics of the fifteenth and sixteenth layers in the fiber preform.

In some embodiments of the present invention, the nano-modified chopped fiber nonwoven fabric has the same size as that of the fiber fabric in the fiber preform. In the examples, in order to test the performance of the obtained fiber composite material, in the fiber preform, a polytetrafluoroethylene film is laid as a pre-crack close to the nano-modified chopped fiber nonwoven fabric. The nano-modified chopped fiber nonwoven fabric and the polytetrafluoroethylene film are in the same layer, and the combined size of the two is the same as that of the fiber fabric in the fiber preform. However, in the process of actual production of the fiber composite materials, no polytetrafluoroethylene film is laid, i.e., the actual fiber composite material product does not contain polytetrafluoroethylene film.

In some embodiments of the present invention, the resin matrix can include a thermosetting resin, which is specifically selected from the group consisting of epoxy resin, unsaturated polyester, phenol formaldehyde resin, vinyl ester, bismaleimide and polyimide, and a mixture thereof. The resin matrix can further include a thermoplastic resin, which is selected from the group consisting of nylon 6, nylon 66, polyether ether ketone, polyether ketone and a mixture thereof. The epoxy resin can be bisphenol F epoxy resin, specifically bisphenol F epoxy resin Epon862.

In some embodiments of the present invention, the molding process is selected from the group consisting of vacuum assisted resin transfer molding (VARTM), resin transfer molding (RTM), hand lay-up molding, autoclave molding, wet molding or sheet molding compound (SMC) and a mixture thereof; specifically, vacuum assisted resin transfer molding (VARTM).

In some embodiments of the present invention, the composite molding using a resin matrix by a molding process is conducted by a method comprising:
b1) preparing a resin matrix slurry;
b2) uniformly introducing the resin matrix slurry into the fiber preforms, and curing after the resin matrix slurry is filled to obtain a fiber composite material.

In step b1):

In some embodiments of the present invention, the resin matrix slurry is prepared by a method comprising:
stirring and mixing a resin matrix with a curing agent, and degassing the mixture to obtain a resin matrix slurry.

The curing agent is Polyetheramine D-230.

A mass ratio of the resin matrix to the curing agent is 100:30-40; specifically, 100:35.2.

In some embodiments, the degassing is carried out in a vacuum oven at 25° C. for 10 min.

In step b2):

In some embodiments of the present invention, the resin matrix slurry is uniformly introduced into the fiber preform by using a double-layer flow guiding net.

In some embodiments of the present invention, before the resin matrix slurry is uniformly introduced into the fiber preform by using a double-layer flow guiding net, the method further comprises:
separating the double-layer flow guiding net and the fiber preform with a demoulding fabric, and then sealing them in a vacuum bag.

In some embodiments of the present invention, the resin matrix slurry is uniformly introduced into the fiber preform by using a double-layer flow guiding net through a vacuum pump.

The curing is carried out in a flat vulcanizer.

The curing comprises:
firstly curing at 75-85° C. and 0.8-1.2 MPa for 1.5-2.5 h, and then at 115-125° C. for 1.5-2.5 h;
specifically, firstly curing at 80° C. and 1 MPa for 2 h, and then at 120° C. for 2 h.

In some embodiments of the present invention, after the curing, the method further comprises: cooling and demoulding to obtain a fiber composite material.

The present invention has no special limitation on the sources of raw materials used above, which can be generally commercially available.

The present invention further provides a fiber composite material prepared by the above method. In some embodiments of the present invention, the fiber composite material has a thickness of 3.8-6 mm; specifically, 3.8 mm or 6 mm.

In order to further illustrate the present invention, the fiber composite material provided by the present invention and the preparation method thereof will be described in detail below in conjunction with the examples, which should not be construed as limiting the protection scope of the present invention.

In the examples, the aminated multi-walled carbon nanotubes are the aminated multi-walled carbon nanotubes TNSMN1 produced by Chengdu Organic Chemicals Co., Ltd., Chinese Academy of Sciences.

### Example 1

The fiber composite material was prepared by a method comprising the following steps:

1. Uniformly dispersing aminated multi-walled carbon nanotubes in an acetone solution to obtain a nanoparticle dispersion:

0.625 g of aminated multi-walled carbon nanotubes (with a length ranging from 0.5 to 2 μm, an average length of 1.0 μm, and a diameter of <8 nm) was weighed, then put into an agate mortar, and ground to break up large carbon nanotube agglomerates. The ground carbon nanotubes were added with 100 g of acetone. The resulting mixture was stirred with a glass rod, sealed, and then ultrasonicated for 30 min at room temperature (25° C.). The ultrasonicated solution was dispersed by a micro jet (through a micro jet high-pressure homogenizer) 6 times, wherein for each dispersion, the carbon nanotubes remaining on the inner wall of the device needed to be washed with acetone into the micro jet device for dispersion, to obtain a nanoparticle dispersion.

2. Preparing a chopped fiber nonwoven fabric:

1 g of carbon fiber with a length of 4 mm was placed in a beaker, and added with 100 g of water and 0.1 g of a surfactant. The resulting mixture was stirred to uniformly disperse the carbon fiber, and subjected to suction filtration. The filter residue was rinsed with deionized water, and then dried in a vacuum oven to obtain a chopped fiber nonwoven fabric with a thickness of 50 μm.

3. Spraying the nanoparticle dispersion on the chopped fiber nonwoven fabric:

The nanoparticle dispersion was poured into a high-pressure spray gun (a W-71 Siphon spray gun), and the spray gun was connected to an air compressor (recommended with an air purifier) or a nitrogen bottle. The nanoparticle dispersion was evenly spray-coated on both sides of the chopped fiber nonwoven fabric at a pressure of 0.30 MPa and a distance of 30 cm. The nanoparticles are spray-coated at an areal density of 0.3 g/m². The spray-coated chopped fiber nonwoven fabric was then dried in a vacuum oven to obtain a nano-modified chopped fiber nonwoven fabric.

4. Preparing a fiber preform:

A unidirectional carbon fiber fabric (Toray T300-3000 with a density of 1.76 g/cm³) was cut into a fabric of 25 cm×25 cm. 16 layers of the fabrics were then stacked and arranged in the sequence of [0°]₁₆ to obtain a fiber preform.

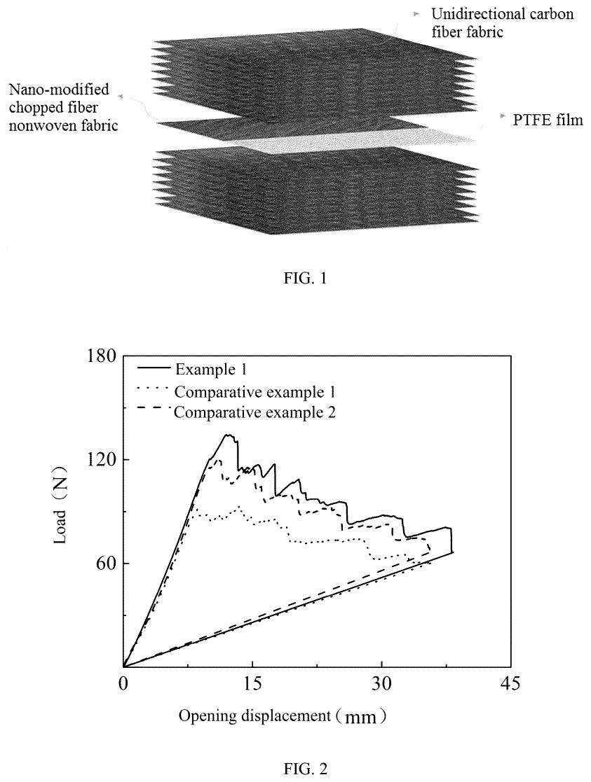

The nano-modified chopped fiber nonwoven fabric was intercalated between the fiber fabrics of the eighth and ninth layers in the fiber preform. Meanwhile, a polytetrafluoroethylene film (a PIM film with a thickness of 13 μm) with a length of 45 mm was laid as a pre-crack close to the nano-modified chopped fiber nonwoven fabric (as shown in FIG. 1; the nano-modified chopped fiber nonwoven fabric and the polytetrafluoroethylene film were in the same layer, and the combined size of the two was the same as that of the above fabric). FIG. 1 is a schematic diagram of the laid fiber composite plate used for fracture toughness test in the Example 1 of the present invention.

Remarks: In the above preparation process, the PTFE film was laid only to prepare a double cantilever beam specimen for the subsequent performance testing. In the process of actual production of the composite materials, no PTFE film is laid, i.e., the actual composite product does not contain a PTFE film.

5. Preparing a fiber composite material by a VARTM process:

An epoxy resin matrix slurry was prepared as follows: 300 g of bisphenol F epoxy resin Epon862 was poured into a beaker, and then added with 105.6 g of a curing agent D-230. The resulting mixture was mixed by stirring, and then degased in a vacuum oven at 25° C. for 10 min to obtain 405.6 g of a resin matrix slurry.

A double-layer flow guiding net was applied to the laid fiber preform, where the double-layer flow guiding net and the fiber preform were separated with a demoulding fabric, and they were sealed in a vacuum bag.

The resin matrix slurry was evenly introduced into the fiber preform by negative pressure of a vacuum pump. After the resin matrix slurry was filled, the whole VARTM platform was moved into a flat vulcanizer, cured at 80° C. and 1 MPa for 2 h, then at 120° C. for 2 h, cooled, and demolded, to obtain a fiber composite material with a thickness of 3.8 mm.

### Comparative Example 1

Comparative example 1 was conducted according to the steps and parameters of Example 1 except that in step 4, no nano-modified chopped fiber nonwoven fabric was intercalated between the fiber fabrics of the eighth and ninth layers in the fiber preform, to obtain a fiber composite material with a thickness of 3.8 mm.

### Comparative Example 2

Comparative example 2 was conducted according to the steps and parameters of Example 1 except that the chopped fiber nonwoven fabric was not nano-modified, specifically, in step 4, the chopped fiber nonwoven fabric was intercalated between the fiber fabrics of the eighth and ninth layers in the fiber preform, to obtain a fiber composite material with a thickness of 3.8 mm.

The fiber composite materials obtained in Example 1 and Comparative examples 1-2 were cut into 230 mm×21 mm, and then were tested as follows:

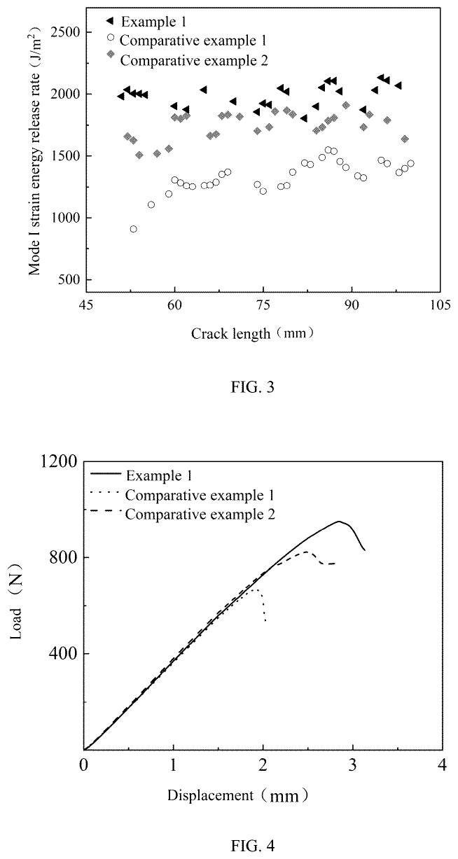

1) According to the standard ASTM D5528, an evaluation on mode I interlaminar fracture toughness was carried out. The results are as shown in FIG. 2 and FIG. 3, where FIG. 2 is a diagram of the result of the double cantilever beam test on the fiber composite materials of Example 1 and Comparative examples 1-2, and FIG. 3 is a R curve diagram of the fiber composite materials of Example 1 and Comparative examples 1-2 (a curve of crack growth resistance versus crack growth). It can be seen that, compared with the reference sample of Comparative example 1, the mode I interlaminar fracture toughness of the composite material plate of Example 1 increased from 1.23 kJ/m² to 2.02 kJ/m², showing an increase of 64%. Compared with Comparative example 2, it also showed an increase of more than 10%.

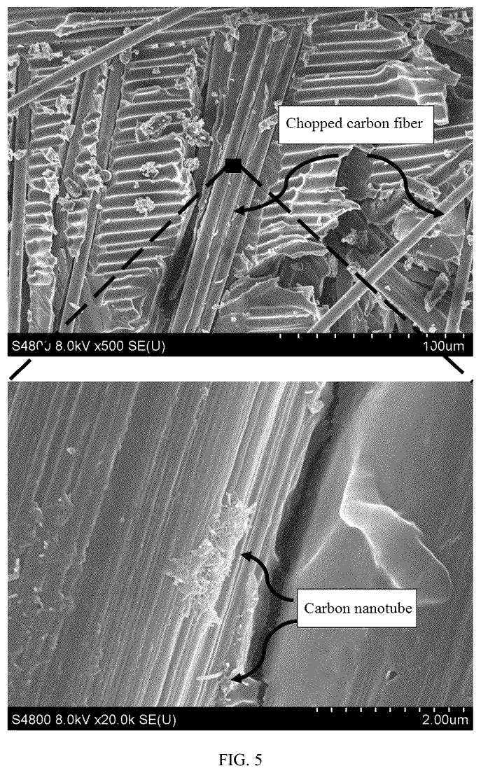

2) According to the standard ASTM D7905, an evaluation on mode II interlaminar fracture toughness was carried out. FIG. 4 shows a result of the end-notched flexure (ENF) test on the fiber composite materials of Example 1 and Comparative examples 1-2. The mode II interlaminar fracture toughness of Example 1 was calculated to be 0.94 kJ/m², showing an increase of nearly 81% compared with 0.52 kJ/m² of Comparative example 1, and it also showed an increase of nearly 8% compared with 0.87 kJ/m² of Comparative example 2.

FIG. 5 is SEM images of the mode I fracture surface of the fiber composite material in Example 1 of the present invention. In particular, the upper image in FIG. 5 is an SEM image under the magnification of ×500, and the lower image is an SEM image under the magnification of ×20000. It can be seen from FIG. 5 that the intercalation of the nano-modified chopped fiber nonwoven fabrics can create a multi-scale fiber bridging mechanism, which greatly improves the interlaminar fracture toughness of the fiber-reinforced composite materials.

### Example 2

The fiber composite material was prepared by a method comprising the following steps:

1. Uniformly dispersing aminated multi-walled carbon nanotubes in an acetone solution to obtain a nanoparticle dispersion:

0.625 g of aminated multi-walled carbon nanotubes (with a length ranging from 0.5 to 2 μm, an average length of 1.0 μm, and a diameter of <8 nm) was weighed, then put into an agate mortar and ground to break up large carbon nanotube agglomerates. The ground carbon nanotubes were added with 100 g of acetone. The resulting mixture was stirred with a glass rod, sealed, and then ultrasonicated for 30 min at room temperature (25° C.). The ultrasonicated solution was dispersed by a micro jet (through a micro jet high-pressure homogenizer) 6 times, wherein for each dispersion, the carbon nanotubes remaining on the inner wall of the device needed to be washed with acetone into the micro jet device for dispersion, to obtain a nanoparticle dispersion.

2. Preparing a chopped fiber nonwoven fabric:

1 g of carbon fiber with a length of 4 mm was placed in a beaker, and added with 100 g of water and 0.1 g of a surfactant. The resulting mixture was stirred to uniformly disperse the carbon fiber, and subjected to suction filtration. The filter residue was rinsed with deionized water, and then dried in a vacuum oven to obtain a chopped fiber nonwoven fabric with a thickness of 50 μm.

3. Spraying the nanoparticle dispersion on the chopped fiber nonwoven fabric:

The nanoparticle dispersion was poured into a high-pressure spray gun (a W-71 Siphon spray gun), and the spray gun was connected to an air compressor (recommended with an air purifier) or a nitrogen bottle. The nanoparticle dispersion was evenly spray-coated on both sides of the chopped fiber nonwoven fabric at a pressure of 0.30 MPa and a distance of 30 cm. The nanoparticles are spray-coated at an areal density of 0.5 g/m². The spray-coated chopped fiber nonwoven fabric was then dried in a vacuum oven to obtain a nano-modified chopped fiber nonwoven fabric.

4. Preparing a fiber preform:

A bidirectional glass fiber fabric was cut into a fabric of 25 cm×25 cm. 30 layers of the fabrics were then stacked and arranged in the sequence of [0°]₃₀ to obtain a fiber preform.

The nano-modified chopped fiber nonwoven fabric was intercalated between the fiber fabrics of the fifteenth and sixteenth layers in the fiber preform. Meanwhile, a polytetrafluoroethylene film (a PTFE film with a thickness of 13 μm) with a length of 45 mm was laid as a pre-crack close to the nano-modified chopped fiber nonwoven fabric. The nano-modified chopped fiber nonwoven fabric and the polytetrafluoroethylene film were in the same layer, and the combined size of the two was the same as that of the above fabric.

Remarks: In the above preparation process, the PTFE film was laid only to prepare a double cantilever beam specimen for the subsequent performance testing. In the process of actual production of the composite materials, no PTFE film is laid, i.e., the actual composite product does not contain a PTFE film.

5. Preparing a fiber composite material by a VARTM process:

An epoxy resin matrix slurry was prepared as follows: 300 g of bisphenol F epoxy resin Epon862 was poured into a beaker, and then added with 105.6 g of a curing agent polyetheramine D-230. The resulting mixture was mixed by stirring, and then degased in a vacuum oven at 25° C. for 10 min to obtain 405.6 g of a resin matrix slurry.

A double-layer flow guiding net was applied to the laid fiber preform, where the double-layer flow guiding net and the fiber preform were separated with a demoulding fabric, and then they were sealed in a vacuum bag.

The resin matrix slurry was evenly introduced into the fiber preform by negative pressure of a vacuum pump. After the resin matrix slurry was filled, the whole VARTM platform was moved into a flat vulcanizer, cured at 80° C. and 1 MPa for 2 h, then at 120° C. for 2 h, cooled, and demolded to obtain a fiber composite material.

The fiber composite material had a thickness of 6 mm. The fiber composite material was cut into 230 mm×21 mm for a hinged double cantilever beam (DCB) test (ASTM D5528) and an end-notched flexure (ENF) test (ASTM D7905) respectively. It was measured that the mode I interlaminar fracture toughness (G_{IC}) was 1.30 kJ/m², and the mode II interlaminar fracture toughness (G_{IIC}) was 0.43 kJ/m².

The above description of the disclosed examples is provided to enable those skilled in the art to make or use the present invention. Various modifications to these examples are readily apparent to those skilled in the art, and the general principles defined herein may be implemented in other embodiments without departing from the spirit or scope of the present invention. Therefore, the present invention will not be limited to the examples shown herein, but is to be accorded the widest scope consistent with the principles and novel features disclosed herein.

1. A method for preparing a fiber composite material, comprising steps of:
A) uniformly dispersing nanoparticles in a solvent to obtain a nanoparticle dispersion;
B) uniformly spray-coating the nanoparticle dispersion on a chopped fiber nonwoven fabric, and drying the fabric to obtain a nano-modified chopped fiber nonwoven fabric;
C) intercalating the nano-modified chopped fiber nonwoven fabric between fiber preforms, and subjecting the obtained material and a resin matrix to composite molding by a molding process to obtain a fiber composite material.

2. The method according to claim 1, wherein, in step A), the nanoparticles are selected from the group consisting of carbon nanotubes, graphene, nano-silicon dioxide, boron nitride nanotubes/sheets, nanoclays, carbon nanofibers, carbon nanotube fibers and a mixture thereof.

3. The method according to claim 1, wherein, in step A), the nanoparticles are grafted with a functional group on the surface thereof;
wherein, the functional group is selected from the group consisting of carboxyl, amino and hydroxyl.

4. The method according to claim 1, wherein, in step A), the nanoparticles have a size of less than 2 μm.

5. The method according to claim 1, wherein, in step A), the solvent is selected from the group consisting of water, ethanol, acetone, and a mixture thereof;
and the nanoparticle dispersion has a mass concentration of 0.1%-5%.

6. The method according to claim 1, wherein, in step A), the uniformly dispersing is carried out by a method selected from the group consisting of mechanical stirring, ball milling, grinding, ultrasonic treatment, two/three-roll machine treatment, micro jet treatment and a mixture thereof.

7. The method according to claim 1, wherein, in step B), the chopped fiber nonwoven fabric is prepared by a method comprising:
uniformly dispersing a chopped fiber in water under the action of a surfactant, and subjecting the obtained dispersion to suction filtration to obtain a chopped fiber nonwoven fabric.

8. The method according to claim 7, wherein, in step B), the chopped fiber is selected from the group consisting of a carbon fiber, a glass fiber, a steel fiber, an aramid fiber, a silicon carbide fiber, a plant fiber and a mixture thereof;
the chopped fiber has a length of 0.5 to 15 mm; and
the surfactant is selected from the group consisting of polyvinyl alcohol, hydroxypropyl methylcellulose, methylcellulose, carboxymethyl cellulose and a mixture thereof.

9. The method according to claim 1, wherein, in step C), the fiber preform is prepared with the fiber fabric laid by lamination;
the resin matrix is selected from the group consisting of epoxy resin, unsaturated polyester, phenol formaldehyde resin, vinyl ester, bismaleimide, polyimide, nylon 6, nylon 66, polyether ether ketone, polyether ketone and a mixture thereof; and
the molding process is selected from the group consisting of vacuum assisted resin transfer molding, resin transfer molding, hand lay-up molding, autoclave molding, wet molding, sheet molding and a mixture thereof.

10. A fiber composite material prepared by the method according to claim 1.
